(19) United States
(12) Patent Application Publication
(10) Pub. No.: US 2015/0358347 A1
(43) Pub. Date: Dec. 10, 2015

(54) PREVENTING AN INPUT/OUTPUT BLOCKING ATTACK TO A WIRELESS ACCESS POINT

(71) Applicants: Yongqiang LIU, (US); Shijian LI, (US); Junqing XIE, (US); HEWLETT-PACKARD DEVELOPMENT COMPANY, L.P., Houston, TX (US)

(72) Inventors: Yongqiang LIU, Beijing (CN); Shijian LI, Beijing (CN); Junqing XIE, Beijing (CN)

(21) Appl. No.: 14/762,192

(22) PCT Filed: Jan. 18, 2013
(86) PCT No.: PCT/CN2013/070639

§ 371 Date: Jul. 20, 2015

(51) Int. Cl. H04L 29/06; G06F 17/30; H04W 12/08; H04L 29/12

(52) U.S. Cl. CPC H04L 63/1441; H04L 61/6022; G06F 17/30864; H04W 12/08

(57) ABSTRACT

Systems, methods, and machine-readable and executable instructions are provided for preventing an input/output blocking attack to a wireless access point. Prevention can include instructions to receive a first comeback request from a querying station and to transmit a first portion of a response in a first comeback response frame including an indication of a comeback delay. Prevention can include instructions to receive a second comeback request from the querying station and transmit a second portion of the response in a second comeback response frame in response to the second comeback request complying with the comeback delay. Prevention can include instructions to drop the second comeback request from the querying station in response to the second comeback request not complying with the comeback delay.

### BACKGROUND

The Institute of Electrical and Electronics Engineers (IEEE) 802.11u is an extension of the IEEE 802.11 standard to improve the ability of mobile stations (e.g., laptop computers, smartphones, tablets, etc.) to automatically discover, authenticate, and use a wireless access point (AP), which delivers a cellular network-like mobile broadband experience that users want. An IEEE 802.11u enabled wireless AP may provide an unauthenticated mobile station with query capabilities of the wireless AP and its backhaul access networks before associating with the wireless AP. Examples of environments that may use an IEEE 802.11u wireless AP can include educational campuses, airports, hotels, and/or retail outlets, among others.

### BRIEF DESCRIPTION OF THE DRAWINGS

FIG. 1 is a prior art diagram illustrating an instance of an input/output blocking attack to a wireless access point.

FIG. 2 is a diagram illustrating an example of preventing an input/output blocking attack to a wireless access point according to the present disclosure.

FIG. 3 is a diagram illustrating an example of preventing an input/output blocking attack to a wireless access point according to the present disclosure.

FIG. 4 is a diagram illustrating an example of preventing an input/output blocking attack to a wireless access point according to the present disclosure.

FIG. 5 is a diagram illustrating an example of preventing an input/output blocking attack to a wireless access point according to the present disclosure.

FIG. 6 is a diagram illustrating an example of a wireless access point according to the present disclosure.

FIG. 7 is a flow chart illustrating an example of a method for preventing an input/output blocking attack to a wireless access point according to the present disclosure.

### DETAILED DESCRIPTION

The generic advertisement service (GAS) is a component of IEEE 802.11u that enables a mobile station to query an advertisement server for information elements (IEs) via a wireless AP. GAS provides for layer 2 transport of an advertisement server's responses between the advertisement server, a wireless AP, and a mobile station. The wireless AP is responsible for relaying the mobile station's query to the advertisement server in the carrier's network and for delivering the advertisement server's response back to the mobile station.

To help ensure that mobile stations that are far away from a wireless AP can communicate with the wireless AP, GAS messages are specified to be transmitted with a low frame rate to help protect against wireless signal interference. However, such reliable transmission of GAS messages poses a danger to the wireless AP for input/output (I/O) degradation if the wireless AP has to deliver many relatively large access network query protocol (ANQP) IEs such that normal downstream traffic is affected. ANQP is a query and response protocol used by a mobile station to discover a range of IEs including the operator's domain name, roaming partners accessible via the wireless AP along with their credential type and extensible authentication protocol (EAP) method supported for authentication, Internet protocol (IP) address type availability, among other IEs.

The danger to the wireless AP can be exploited by an I/O attack. An example of an I/O attack includes an attacking station rapidly querying the wireless AP for IEs with different (e.g., spoofing) media access control (MAC) addresses so that the I/O bandwidth of the wireless AP is blocked because the transmission of GAS comeback responses can occupy a lot of air time. To help address this potential attack, systems, methods, and machine-readable and executable instructions are provided for preventing an input/output blocking attack to a wireless access point. Prevention can include instructions to receive a first comeback request from a querying station and to transmit a first portion of a response in a first comeback response frame including an indication of a comeback delay. Prevention can include instructions to receive a second comeback request from the querying station and transmit a second portion of the response in a second comeback response frame in response to the second comeback request complying with the comeback delay. Prevention can include instructions to drop the second comeback request from the querying station in response to the second comeback request not complying with the comeback delay. Examples of the present disclosure can slow down the rate of GAS comeback responses in the wireless AP's transmission queue without significantly increasing query completion time for legitimate mobile stations. Furthermore, examples of the present disclosure do not require operational deviations from the IEEE 802.11u standard that could cause the wireless AP to be noncompliant with the standard.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

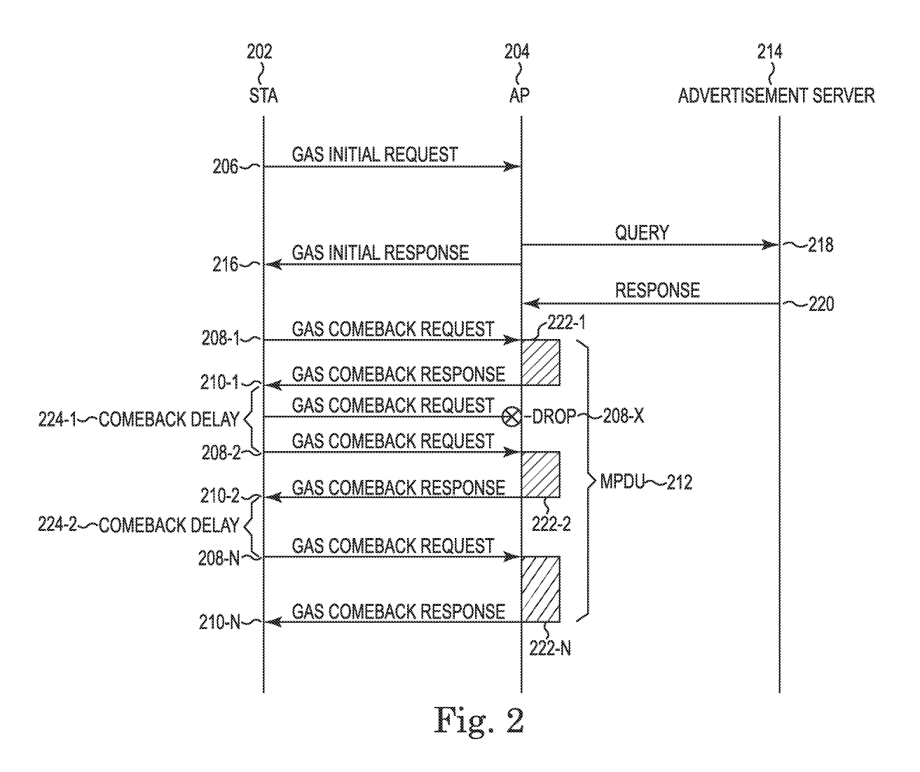

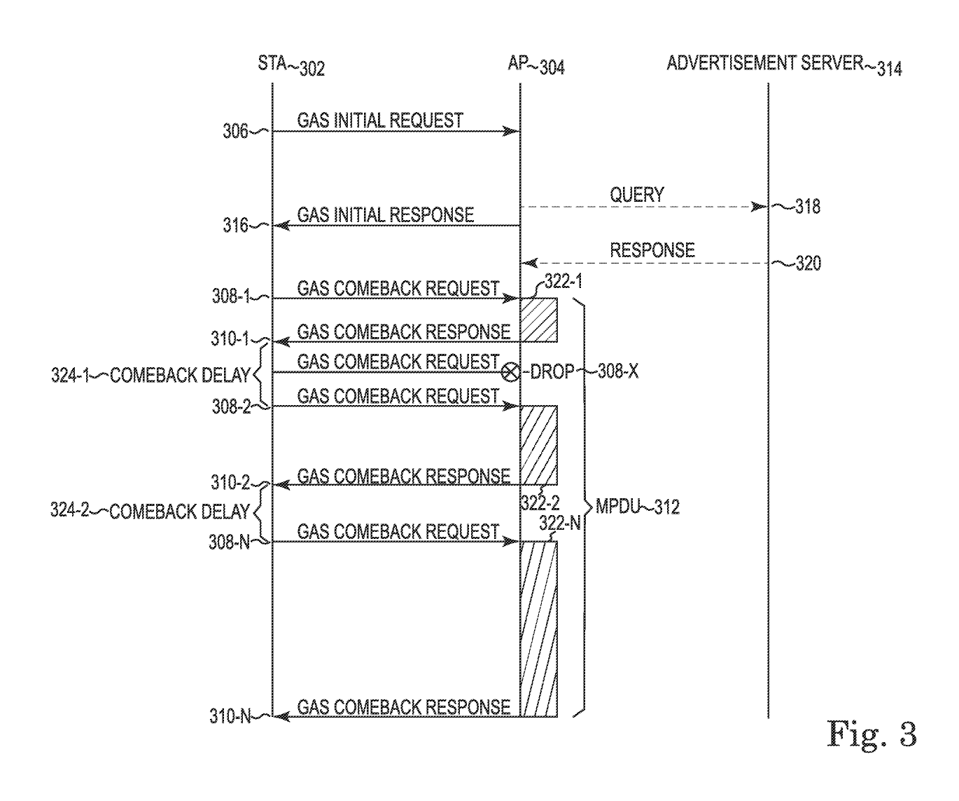

The figures herein follow a numbering convention in which the first digit corresponds to the drawing figure number and the remaining digits identify an element or component in the drawing. For example, reference numeral 204 in FIG. 2 can identify element “04”, while an analogous element may be identified as 304 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

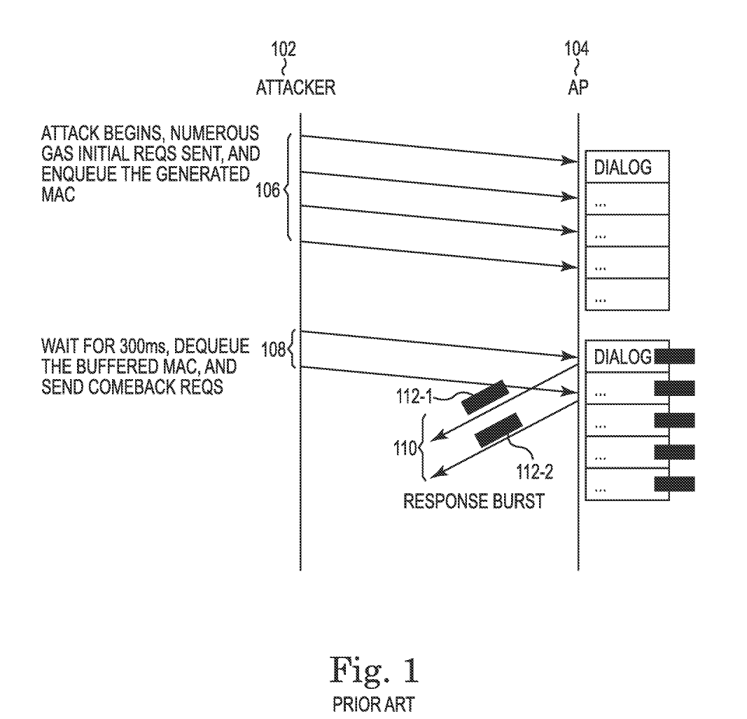

FIG. 1 is a prior art diagram illustrating an instance of an I/O blocking attack to a wireless AP 104. When the wireless interface of the wireless AP 104 is busy for transmission, newly arrived frames (e.g., frames 112-1, 112-2) to be sent may be inserted into a transmission queue of the wireless AP 104 until competition of the transmission of the previous frame. If the wireless interface of the wireless AP 104 is frequently occupied for sending ANQP responses, which can take a relatively long time to finish, the latency of normal downstream data traffic can be prolonged. Furthermore, if a burst of ANQP responses deplete the transmission queue of the wireless AP 104, the downstream data frames may be dropped at the wireless interface of the wireless AP 104, which may cause packet loss for normal communications.

An attacking mobile station 102 may send numerous GAS initial requests 106 with spoofing source MAC addresses to query multiple ANQP IEs such as venue name, network access identifier (NAI) realm list, etc. The attacking mobile station 102 can enqueue the spoofing MAC addresses. When the query responses from the advertisement server (not illustrated in FIG. 1) are buffered by the wireless AP 104, the attacking mobile station 102 may send a burst of GAS comeback requests 108 including the spoofing MAC addresses to fetch the GAS comeback responses 112-1, 112-2 (e.g., the entire responses) each included in a GAS comeback response frame 110, or as much of the response as will fit within the respective frame 110, from the wireless AP 104, which may quickly block the wireless I/O bandwidth of the wireless AP 104. The spoofing MAC addresses make it more difficult for the wireless AP 104 to detect the attack and force the wireless AP 104 to spend more time sending ANQP responses to the spoofing MACs because the responses may not be acknowledged by the interface card of the attacking mobile station 102 due to the difference from the interface's real MAC address. As a result, the wireless AP 104 may retransmit each ANQP response until a retry limit is reached.

FIG. 2 is a diagram illustrating an example of preventing an I/O blocking attack to a wireless AP 204 according to the present disclosure. A mobile station 202 can transmit a GAS initial request 206 to the wireless AP 204. An ANQP query can be encapsulated in the GAS initial request 206 message. The wireless AP 204 can allocate a memory block (control block) to store information of the query such as a mobile station MAC address, a dialog identifier, etc., then send an internal query 218 to an advertisement server 214 (e.g., located in an operator's core network) based on the GAS initial request 206 in response to receiving the GAS initial request 206. Although not specifically illustrated, the wireless AP 204 can query the advertisement server 214 in response to receiving a first GAS comeback request 208-1 that complies with the comeback delay associated with the GAS initial response 208 (e.g., rather than querying the advertisement server 214 in response to receiving the GAS initial request 206). The wireless AP 204 can transmit a GAS initial response 216 to the querying mobile station 202. Although not specifically illustrated, the GAS initial response 216 can include an indication of a comeback delay, which effectively tells the querying mobile station 202 “I will get your information from the advertisement server, please come back later to fetch it.” The wireless AP 204 can store (e.g., in the control block) the ANQP information elements received according to the response 220 from the advertisement server 214.

According to some examples of the present disclosure, the wireless AP 204 can (e.g., via a non-transitory machine readable medium storing instructions executable by a processing resource of the wireless AP 204) receive a first comeback request 208-1 from a querying station 202. The wireless AP 204 can transmit a first portion 222-1 of a response in a first comeback response frame 210-1 including an indication of a comeback delay 224-1. The comeback delay 224-1 instructs the querying station 202 to request a next portion and/or a remainder of the comeback response after a delay of a particular length of time (e.g., x milliseconds). As opposed to a potential solution involving a rate-controllable transmission queue for the wireless access point 204, this solution moves the timer scheduling and overhead from the wireless AP 204 to the querying station 202. The wireless AP 204 can timestamp the first comeback response 210-1 (e.g., t1). The wireless AP 204 can set a timeout of the buffered response 220 from the advertisement server 214 as the comeback delay 224-1 (e.g., x) plus a relaxed estimation of total transmission time of the comeback response frame 210-1 and the comeback request 208-2 (e.g., Δ). For example, assuming that the GAS messages are transmitted at 1 megabit per second (Mbps) and the size of the comeback request 208-2 and comeback response 210-1 is 1000 bits, Δ can be set as

$$7 \times ( \frac{1000}{1 M} + \frac{1000}{1 M} ) = .014 seconds ( 14 ms ) ,$$

assuming that the retry limit is 7. The combination of dropping earlier arriving comeback requests 208-X (described below) and timeout can force querying stations 202 to obey the comeback delay 224-1 or have their subsequent comeback requests dropped.

The wireless AP 204 can receive a second comeback request 208-2 from the querying station 202 and transmit a second portion 222-2 of the response in a second comeback response frame 210-2 in response to the second comeback request 208-2 complying with the comeback delay 224-1. The wireless AP 204 can receive the second comeback request 208-2 at time t2 and verify compliance of the second comeback request 208-2 with the comeback delay 224-1 by checking whether (t2−t1) falls within the range [x, x+Δ]. If (t2−t1) does not fall within the range, the second comeback request 208-2 can be dropped. If (t2−t1) does fall within the range, the wireless AP 204 can take additional actions (e.g., make responses) as described herein. The wireless AP 204 can proactively split the comeback response into portions smaller than an entire maximal packet delivery unit (MPDU) 212 and send one portion 222-1, 222-2, . . . , 222-N in each comeback response frame 210-1, 210-2, . . . , 210-N. For example, the portion 222-1 of the response in comeback response frame 210-1 can be less than a frame capacity of the comeback response frame 210-1. The portions 222-1, 222-2, . . . , 222-N in comeback responses 210-1, 210-2, . . . 210-N can include information from the control block. In some examples, and as illustrated in FIG. 2, the size of the portions 222-1, 222-2, . . . , 222-N can be equal.

The wireless AP 204 can drop the second comeback request 208-X from the querying station 202 in response to the second comeback request 208-X not complying with the comeback delay 224-1. As illustrated in FIG. 2, the second comeback request 208-X can indicate either a comeback request from the original querying station 202 that does not comply with the comeback delay 224-1 (in alternative to the illustrated comeback request 208-2, which does comply with the comeback delay 224-1), or the second comeback request 208-X can indicate a comeback request from a querying station other than station 202 or a same querying station 202 with a different (e.g., spoofing) MAC address. For example, when the first comeback request 208-1 includes a first MAC address for the querying station 202, the wireless AP 204 can drop the comeback request 208-X in response to the comeback request 208-X including a different MAC address and in response to the comeback request 208-X being received during the comeback delay 224-1. This can help the wireless AP 204 prevent the attacks described herein.

FIG. 3 is a diagram illustrating an example of preventing an I/O blocking attack to a wireless AP 304 according to the present disclosure. The mobile station 302, wireless AP 304, advertisement server 314, GAS initial request 306, advertisement server query 318, GAS initial response 316, and response from the advertisement server 320 can be analogous to the mobile station 202, wireless AP 204, advertisement server 214, GAS initial request 206, advertisement server query 218, GAS initial response 216, and response from the advertisement server 220 illustrated and described with respect to FIG. 2.

According to some examples of the present disclosure, the wireless AP 304 can (e.g., via a non-transitory machine readable medium storing instructions executable by a processing resource of the wireless AP 304) receive a first comeback request 308-1 from a querying station 302. The wireless AP 304 can transmit a first portion 322-1, having a first size, of a response in a first comeback response frame 310-1 including an indication of a comeback delay 324-1. The wireless AP 304 can receive a second comeback request 308-2 from the querying station 302 and transmit a second portion 322-2, having a second size that is larger than the first size, of the response in a second comeback response frame 310-2 in response to the second comeback request 308-2 complying with the comeback delay 324-1. The wireless AP 304 can proactively split the comeback response into portions smaller than an entire MPDU 312 and send one portion 322-1, 322-2, . . . , 322-N in each comeback response frame 310-1, 310-2, . . . , 310-N. For example, the portion 322-1 of the response in comeback response frame 310-1 can be less than a frame capacity of the comeback response frame 310-1.

In some examples, and as illustrated in FIG. 3, the size of the portions 322-1, 322-2, . . . , 322-N can be different. For example, the size of a first portion 322-1 can be smaller than the size of a second portion 322-2 (and the size of the second portion 322-2 can be smaller than a size of the nth portion 322-N). The wireless AP 304 can transmit subsequent portions 322-2, . . . , 322-N of the response having sizes larger than previous portions 322-1, 322-2 of the response until an entirety 312 of the response has been transmitted in response to respective comeback requests 308-2, . . . , 308-N complying with respective comeback delays 324-1, 324-2. Such examples can help to reduce query completion time associated with splitting a response into multiple portions 322-1, 322-2, . . . , 322-N and transmitting the portions 322-1, 322-2, . . . , 322-N from the AP 304 to the querying station 302 in multiple GAS comeback response frames 310-1, 310-2, . . . , 310-N. Once (or each time) a querying station 302 complies with a comeback delay 324-1, 324-2, an increased likelihood that the querying station 302 is not an attacking station exists. Thus, the querying station 302 can benefit from complying with the comeback delay(s) 324-1, 324-2 by subsequently receiving larger portion(s) 322-1, 322-2, . . . , 322-N of the response (e.g., until the portion size reaches the MPDU).

The wireless AP 304 can receive a first comeback response from a second querying station (e.g., station 302). The wireless AP 304 can transmit a first portion (e.g., portion 322-1) of a second response including an indication of a comeback delay (e.g., comeback delay 324-1) to the second querying station. The wireless AP 304 can drop a second comeback request 308-X from the second querying station (e.g., station 302) in response to the second comeback request 308-X not complying with the comeback delay (e.g., comeback delay 324-1).

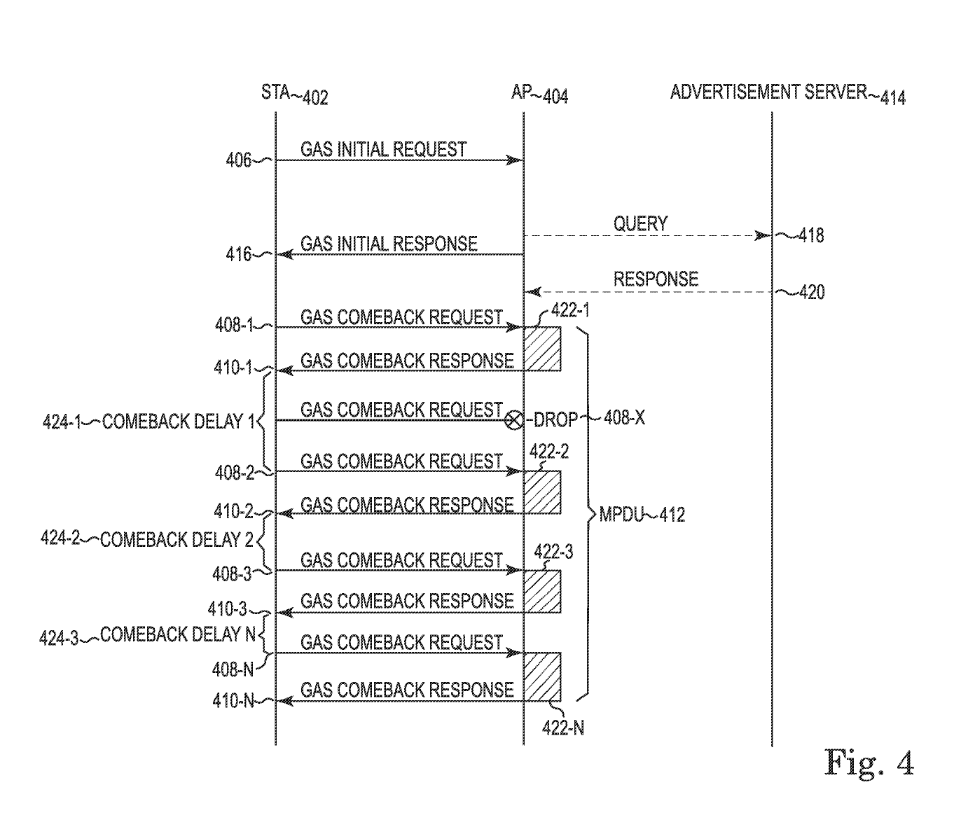

FIG. 4 is a diagram illustrating an example of preventing an I/O blocking attack to a wireless AP 404 according to the present disclosure. The mobile station 402, wireless AP 404, advertisement server 414, GAS initial request 406, advertisement server query 418, GAS initial response 416, and response 420 from the advertisement server 414 can be analogous to the mobile station 202, wireless AP 204, advertisement server 214, GAS initial request 206, advertisement server query 218, GAS initial response 216, and response from the advertisement server 220 illustrated and described with respect to FIG. 2.

According to some examples of the present disclosure, the wireless AP 404 can (e.g., via a non-transitory machine readable medium storing instructions executable by a processing resource of the wireless AP 404) receive a first comeback request 408-1 from a querying station 402. The wireless AP 404 can transmit a first portion 422-1 of a response in a first comeback response frame 410-1 including an indication of a first comeback delay 424-1. The wireless AP 404 can receive a second comeback request 408-2 from the querying station 402 and transmit a second portion 422-2 of the response in a second comeback response frame 410-2 including an indication of a second comeback delay 424-2 that is shorter than the first comeback delay 424-1 in response to the second comeback request 408-2 complying with the first comeback delay 424-1. The wireless AP 402 can transmit subsequent portions 422-2, 422-3, . . . , 422-N of the response including indications of subsequent comeback delays 424-2, 424-3 that are shorter than previous comeback delays 424-1, 424-2 included with previous portions 422-1, 422-2, 422-3 of the comeback response in response to respective comeback requests 408-2, 408-3, . . . , 408-N complying with respective comeback delays 424-1, 424-2, 424-3. Such examples can help to reduce query completion time associated with splitting a response into multiple portions 422-1, 422-2, 422-3, . . . , 422-N and transmitting the portions 422-1, 422-2, 422-3, . . . , 422-N from the AP 404 to the querying station 402 in multiple GAS comeback response frames 410-1, 410-2, 410-3, . . . , 410-N. Once (or each time) a querying station 402 complies with a comeback delay 424-1, 424-2, an increased likelihood that the querying station 402 is not an attacking station exists. Thus, the querying station 402 can benefit from complying with the comeback delay(s) 424-1, 424-2 by subsequently having shorter comeback delays 424-1, 424-2, 424-3 associated with respective GAS comeback response frames 410-1, 410-2, 410-3, . . . , 410-N.

The wireless AP 404 can proactively split the comeback response into portions smaller than an entire MPDU 412 and send one portion 422-1, 422-2, 422-3, . . . , 422-N in each comeback response frame 410-1, 410-2, 410-3, . . . , 410-N. For example, the portion 422-1 of the response in comeback response frame 410-1 can be less than a frame capacity of the comeback response frame 410-1. In some examples, and as illustrated in FIG. 4, the size of the portions 422-1, 422-2, 422-3, . . . , 422-N can be equal. Any comeback request can be dropped in response to the comeback request not complying with a respective comeback delay. For example, the wireless AP 404 can drop the second comeback request 408-X from the querying station 402 in response to the second comeback request 408-X not complying with the first comeback delay 424-1.

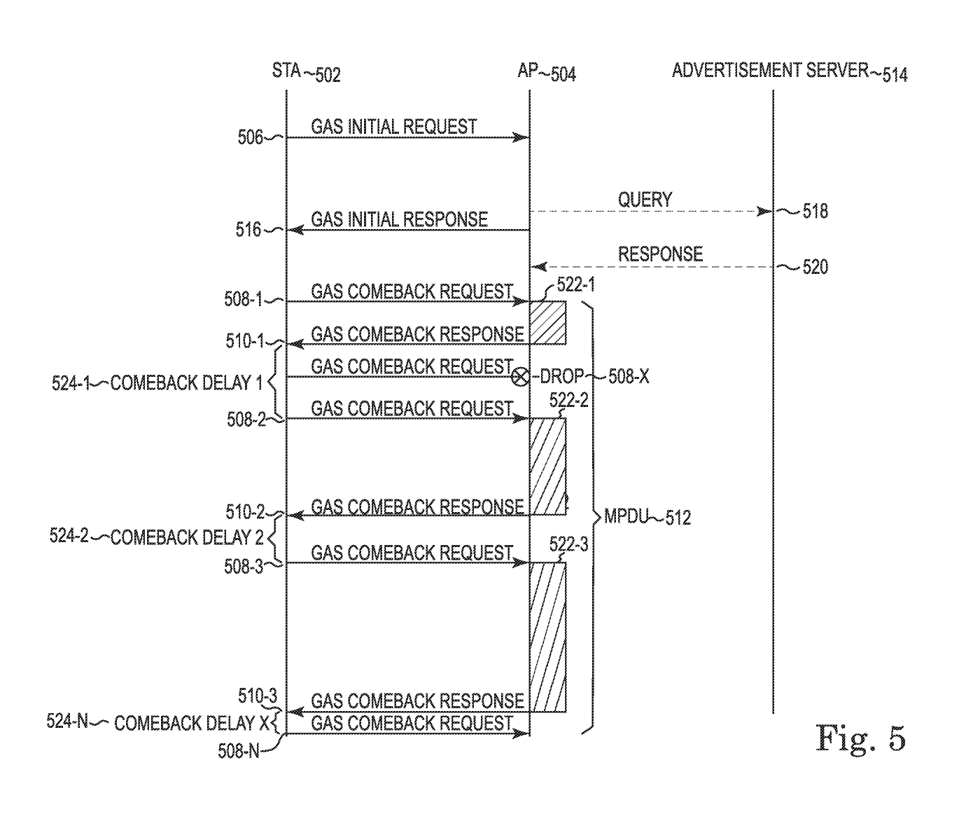

FIG. 5 is a diagram illustrating an example of preventing an I/O blocking attack to a wireless AP 504 according to the present disclosure. The mobile station 502, wireless AP 504, dropped GAS comeback request 508-X, MPDU 512, advertisement server 514, GAS initial request 306, advertisement server query 518, GAS initial response 516, and response from the advertisement server 514 can be analogous to the mobile station 202, wireless AP 204, dropped GAS comeback request 208-X, MPDU 212, advertisement server 214, GAS initial request 206, advertisement server query 218, GAS initial response 216, and response from the advertisement server 220 illustrated and described with respect to FIG. 2.

According to some examples of the present disclosure, the wireless AP 504 can (e.g., via a non-transitory machine readable medium storing instructions executable by a processing resource of the wireless AP 504) receive a first comeback request 508-1 from a querying station 502. The wireless AP 504 can transmit a first portion 522-1, having a first size, of a response in a first comeback response frame 510-1 including an indication of a first comeback delay 524-1. The wireless AP 504 can receive a second comeback request 508-2 from the querying station 502 and transmit a second portion 522-2, having a second size greater than the first size of the first portion 522-1, of the response in a second comeback response frame 510-2 including an indication of a second comeback delay 524-2 that is shorter than the first comeback delay 524-1 in response to the second comeback request 508-2 complying with the first comeback delay 524-1.

The wireless AP 502 can transmit subsequent portions 522-2, 522-3 of the response having sizes larger than previous portions 522-1, 522-2 of the response and including indications of subsequent comeback delays 524-2, 524-N that are shorter than previous comeback delays 524-1, 524-2 included with previous portions 522-1, 522-2 of the comeback response in response to respective comeback requests 508-2, 508-3, . . . , 508-N complying with respective comeback delays 524-1, 524-2, . . . , 524-N until an entirety 512 of the response has been transmitted in response to respective comeback requests 508-2, . . . , 508-N complying with respective comeback delays 524-1, 524-2, . . . , 524-N. Such examples can help to reduce query completion time associated with splitting a response into multiple portions 522-1, 522-2, 522-3 and transmitting the portions 522-1, 522-2, 522-3 from the AP 504 to the querying station 502 in multiple GAS comeback response frames 510-1, 510-2, 510-3. Once (or each time) a querying station 502 complies with a comeback delay 524-1, 524-2, . . . , 524-N, an increased likelihood that the querying station 502 is not an attacking station exists. Thus, the querying station 502 can benefit from complying with the comeback delay(s) 524-1, 524-2, . . . , 524-N by subsequently receiving larger portion(s) 522-1, 522-2, 522-3 of the response and by subsequently having shorter comeback delays 524-1, 524-2, . . . , 524-N associated with respective GAS comeback response frames 510-1, 510-2, 510-3. Changes in the size of the portions and/or the length of the comeback delays can be secret to querying stations to help prevent an attacking station from guessing the comeback delay for making legitimate comeback requests.

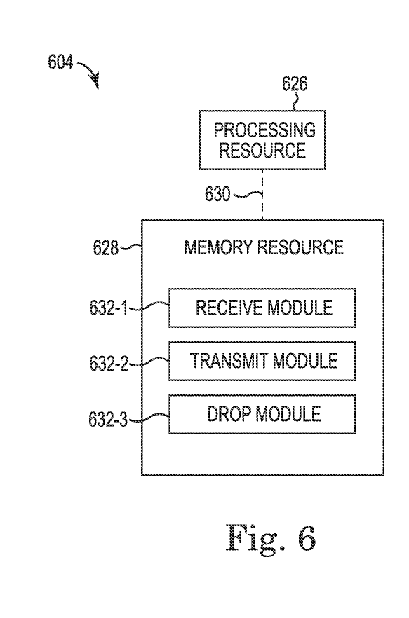

FIG. 6 is a diagram illustrating an example of a wireless AP 604 according to the present disclosure. The wireless AP 604 can utilize software, hardware, firmware, and/or logic to perform a number of functions. The wireless AP 604 can be a combination of hardware and program instructions configured to perform a number of functions (e.g., actions). The hardware, for example, can include a number of processing resources 626 and a number of memory resources 628, such as a machine-readable medium (MRM) or other memory resources 628. The memory resources can be internal and/or external to the wireless AP 604 (e.g., the wireless AP 604 can include internal memory resources and have access to external memory resources). The program instructions (e.g., machine-readable instructions (MRI)) can include instructions stored on the MRM to implement a particular function (e.g., an action such as preventing an I/O blocking attack). The set of MRI can be executable by one or more of the processing resources 626. The memory resources 628 can be coupled to the wireless AP 604 in a wired and/or wireless manner. For example, the memory resources 628 can be an internal memory, a portable memory, a portable disk, and/or a memory associated with another resource, e.g., enabling MRI to be transferred and/or executed across a network such as the Internet.

Memory resources 628 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 626 can be coupled to the memory resources 628 via a communication path 630. The communication path 630 can be local or remote to the wireless AP 604. Examples of a local communication path 630 can include an electronic bus internal to a machine, where the memory resources 628 are in communication with the processing resources 626 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 630 can be such that the memory resources 628 are remote from the processing resources 626, such as in a network connection between the memory resources 628 and the processing resources 626. That is, the communication path 630 can be a network connection. Examples of such a network connection can include local area network (LAN), wide area network (WAN), personal area network (PAN), and the Internet, among others.

As shown in FIG. 6, the MRI stored in the memory resources 628 can be segmented into a number of modules 632-1, 632-2, 632-3 that when executed by the processing resources 626 can perform a number of functions. As used herein a module includes a set of instructions included to perform a particular task or action. The number of modules 632-1, 632-2, 632-3 can be sub-modules of other modules. For example, the drop module 632-3 can be a sub-module of the receive module 632-1 and/or the drop module 632-3 and the receive module 632-1 can be contained within a single module. Furthermore, the number of modules 632-1, 632-2, 632-3 can comprise individual modules separate and distinct from one another. Examples are not limited to the specific modules 632-1, 632-2, 632-3 illustrated in FIG. 6.

The receive module 632-1 can comprise MRI that can be executed by the processing resources 626 to receive requests (e.g., GAS initial requests, GAS comeback requests, etc.) from a querying station and/or to receive responses from an advertisement server, among other receptions, as described herein. Although not specifically illustrated, the receive module 632-1 can make use of a number of antennas associated with the wireless AP 604.

The transmit module 632-2 can comprise MRI that are executed by the processing resources 626 to transmit responses (e.g., GAS initial response, GAS comeback responses, etc.) to a querying station and/or to transmit queries to an advertisement server, among other transmissions, as described herein. Although not specifically illustrated, the transmit module 632-2 can make use of a number of antennas associated with the wireless AP 604.

The drop module 632-3 can comprise MRI that are executed by the processing resources 626 to drop requests (e.g., GAS comeback requests) received from a querying station in response to the requests not complying with a comeback delay, in response to the requests not having a MAC address in an appropriate control block in the memory resources 628 of the wireless AP 604, and/or in response to other conditions as described herein.

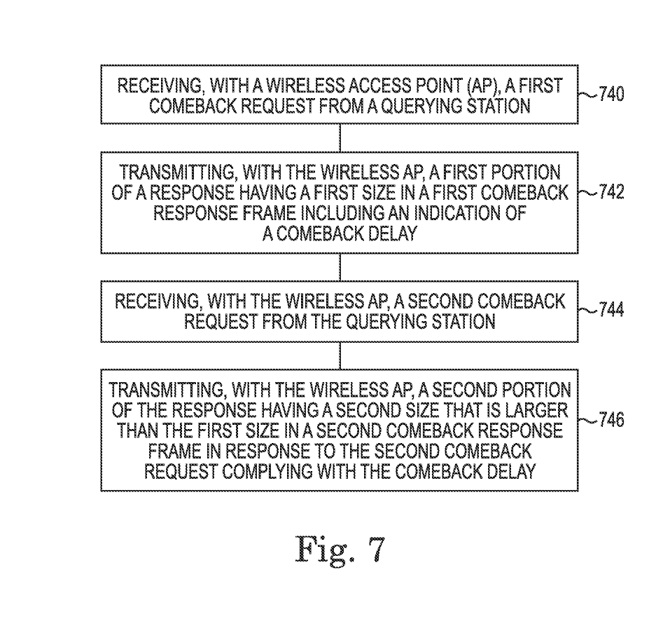

FIG. 7 is a flow chart illustrating an example of a method for preventing an input/output blocking attack to a wireless access point according to the present disclosure. At block 740, a first comeback request from a querying station can be received with a wireless AP. At block 742, a first portion of a response can be transmitted with the wireless AP in a first comeback response frame having a first size and including an indication of a comeback delay. At block 744, a second comeback request can be received from the querying station with the wireless AP. At block 746, a second portion of the response can be transmitted with the wireless AP in a second comeback response frame having a size that is larger than the first size in response to the second comeback request complying with the comeback delay.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A non-transitory machine-readable medium storing instructions to prevent an input/output blocking attack to a wireless access point (AP) executable by the wireless AP to cause the wireless AP to:
receive a first comeback request from a querying station;
transmit a first portion of a response in a first comeback response frame including an indication of a comeback delay;
receive a second comeback request from the querying station and transmit a second portion of the response in a second comeback response frame in response to the second comeback request complying with the comeback delay; and
drop the second comeback request from the querying station in response to the second comeback request not complying with the comeback delay.

2. The medium of claim 1, wherein the first comeback request includes a first media access control (MAC) address for the querying station; and
wherein the instructions are executable to cause the wireless AP to drop a third comeback request from the querying station including a second MAC address for the querying station in response to the third comeback request being sent during the comeback delay.

3. The medium of claim 1, wherein the first portion of the response comprises less than a frame capacity of the first comeback response frame, and wherein the first portion of the response comprises only the indication of the comeback delay.

4. The medium of claim 1, wherein the instructions are executable to:
buffer a remainder of the response including at least the second portion of the response; and
set a timeout for the remainder of the response.

5. The medium of claim 1, wherein a size of the first portion is equal to a size of the second portion.

6. The medium of claim 1, wherein a size of the first portion is smaller than a size of the second portion.

7. The medium of claim 1, wherein the instructions are executable to transmit the second portion of the response including an indication of a second comeback delay that is shorter than the comeback delay for the first portion in response to the second comeback request complying with the comeback delay.

8. The medium of claim 1, wherein the instructions are executable to transmit subsequent portions of the response having sizes larger than previous portions of the response and including indications of subsequent comeback delays that are shorter than previous comeback delays included with previous portions of the response in response to respective comeback requests complying with respective comeback delays.

9. A method of preventing an input/output blocking attack to a wireless access point (AP) comprising:
receiving, with the wireless AP, a first comeback request from a querying station;
transmitting, with the wireless AP, a first portion of a response having a first size in a first comeback response frame including an indication of a comeback delay;
receiving, with the wireless AP, a second comeback request from the querying station; and
transmitting, with the wireless AP, a second portion of the response having a second size that is larger than the first size in a second comeback response frame in response to the second comeback request complying with the comeback delay.

10. The method of claim 9, wherein the method includes transmitting subsequent portions of the response having sizes larger than previous portions of the response, until an entirety of the response has been transmitted, in response to respective comeback requests complying with respective comeback delays.

11. The method of claim 9, wherein the method includes:
receiving, with the wireless AP, a first comeback request from a second querying station;
transmitting, with the wireless AP, a first portion of a second response including an indication of a comeback delay to the second querying station; and
dropping, with the wireless AP, a second comeback request from the second querying station in response to the second comeback request not complying with the comeback delay.

12. The method of claim 9, wherein the method includes:
receiving, with the wireless AP, a generic advertisement service (GAS) initial request from the querying station prior to receiving the first comeback request;
querying, with the wireless AP, an advertisement server based on the GAS initial request in response to receiving the first comeback request from the querying station; and
storing, with the wireless AP, a response from the advertisement server in a control block in a memory of the wireless AP, wherein the first and the second portions of the response include information from the control block.

13. A wireless access point (AP), comprising:
a processing resource in communication with a memory resource, wherein the memory resource includes a set of instructions to prevent an input/output blocking attack to the wireless AP, executable by the processing resource to:
receive a first comeback request from a querying station;
transmit a first portion of a response in a first comeback response frame including an indication of a first comeback delay;
receive with the wireless AP, a second comeback request from the querying station; and
transmit a second portion of the response in a second comeback response frame including an indication of a second comeback delay that is shorter than the first comeback delay in response to the second comeback request complying with the first comeback delay.

14. The wireless AP of claim 13, wherein the instructions are executable to transmit subsequent portions of the response including indications of subsequent comeback delays that are shorter than previous comeback delays included with previous portions of the comeback response in response to respective comeback requests complying with respective comeback delays.

15. The wireless AP of claim 13, wherein the instructions are executable to drop the second comeback request from the querying station in response to the second comeback request not complying with the first comeback delay.
